(19) United States
(12) Patent Application Publication
(10) Pub. No.: US 2022/0067600 A1
(43) Pub. Date: Mar. 3, 2022

(54) A METHOD TO MEASURE WORK PRODUCTION IN FOREST OPERATIONS

(71) Applicant: OY ARBONAUT LTD., Joensuu (FI)

(72) Inventors: Vesa LEPPÄNEN, Joensuu (FI); Jari KINNUNEN, Joensuu (FI)

(73) Assignee: OY ARBONAUT LTD., Joensuu (FI)

(21) Appl. No.: 16/763,883

(22) PCT Filed: Nov. 15, 2018
(86) PCT No.: PCT/FI2018/050837

§ 371 Date: May 13, 2020

(30) Foreign Application Priority Data
Nov. 17, 2017 (FI) 20176029

(51) Int. Cl. G06Q 10/06; G06Q 50/16

(52) U.S. Cl. CPC G06Q 10/0633; G06Q 10/06393; G06Q 50/165

(57) ABSTRACT

A method measuring work production in forest operations is disclosed. The method utilizes Tracking trail and Reach of equipment with Work Quantification Information from remote sensing to measure work production. Using the method the organizations or persons involved in forest work can follow the production done and the related productivity.

### DESCRIPTION OF BACKGROUND

The following disclosure relates to measuring work production in forest operations. Particularly, the disclosure relates to a system and method measuring work production in forest operations and a process for facilitating the measurement.

Measuring work performance and its productivity are critical to effective operations. There are many reasons why organizations and individuals are interested in the work production; including but not limited to:
Reporting the work performed
Improving the productivity
Compensating the work to the participants
Comparing individuals and alternative equipment
For personal development
For motivational reasons

Some examples of forest operations where the work performance measurements are interesting for the organizations or individuals:
Logging
Site preparation
Planting
Thinning or pre-commercial thinning
Drainage system construction and maintenance
Plantation tending or treatment, removal of undesirable vegetation

Measuring work performed is a challenge in some forest operations. Some of the machinery used in forest operations are equipped with sensors or other means to measure the production, but there are work phases and processes where such productivity information is not easy to obtain.

Remote sensing is an art known to mankind. Remote sensing may be performed using for example satellite or airborne sensors, operated from manned or unmanned vessels. Sensors most commonly used include spectral sensors (cameras, spectrometers etc.), LiDAR sensors and radar sensors, but other kinds are known to be used as well.

Remote sensing has capability to produce information about the target of the work. This information may be geographically two-dimensional or three dimensional, but can also include more dimensions, like time. Some examples of work-related information include timber volume, amount of unwanted vegetation on the target area or area of land to be processed. Also number, size or diameter of trees processed may be of interest to work production measurements in forest operations. For example, mean size of the trees processed may have an impact to the time it takes to process certain volume of wood material. Straightness of stem or number and diameter of branches may also cause variation in the processing productivity, and thus, be of interest in production measurements.

Three dimensional point clouds have been used quite extensively in sensing. Point clouds can be produced using multiple techniques, LiDAR, photogrammetry and radargrammetry being just a few. A brief presentation of some of the techniques area presented here.

Photogrammetry is the science of making measurements from photographs. Stereophotogrammetry is a methodology of photogrammetry where group of two or more images taken of the same target are analyzed. The images have to be taken from different viewpoints, presenting the objects at different distance from the observing sensors at different locations in the imaging sensor. Corresponding features are identified in different images and their relative location on the image are interpreted to extract the 3D location of the objects on the real life. The sensor locations may be given to the algorithm or, alternatively, deduced from the analysis.

LiDAR, known also as laser scanning, has been used for forest inventories approximately since 1990's. LiDAR is an active instrument that uses laser ranging, combined with devices measuring position and attitude of the sensor, to produce 3D location measurements of objects. The sensor emits a laser beam to a known direction from a known position and records the distance to surfaces where the beam is reflected back. Additionally, LiDAR may have capability to record the intensity of the returning signal, indicating the reflectivity and size of the reflecting surfaces. The laser beam is projected to the object through a mirror or prism system or other kind of optical setup (the “LiDAR Optic”) that causes the laser beam to scan the target area, recording the precise direction where the beam was sent each time to allow construction of the 3D measurements.

Traditionally, LiDAR has been used to produce attributes to areas of land. For example, LiDAR-derived attributes have been assigned to timber stands, making management or inventory units.

Because of its capability to measure vegetation height and canopy densities, LiDAR has been widely accepted in forest inventory purposes (1). LiDAR inventories represent a significant economic value, the volume of LiDAR inventory in Finland alone is about 3-million hectares annually (2013), replacing approximately 45-60 million euros worth of fieldwork. Other Scandinavian countries, Sweden and Norway, being in the forefront of operational forest inventory from LiDAR, represent corresponding volumes.

Radargrammetry is the technology of extracting geometric object information from radar images. The output of the radargrammetric analysis may be for example a geometric three dimensional point cloud. Like stereophotogrammetry and LiDAR, also radargrammetry can be used from airborne or satellite, ground and water vessel platforms.

Machinery used in forest operations, but also the personnel, may be equipped with positioning equipment, allowing to follow the location of the machinery or the persons during the performance of the work. The series of locational measurements in time line can be called the “the tracking trail” or “the tracking tail” of the equipment or person. For consistency, the term “tracking trail” is used in this document further on, the meaning being the same in either case.

It is understandable that the work can be conducted at some reach, “the reach” of the equipment, tools or persons performing the work. The reach can be defined as the distance from the equipment or personnel location to the points where the work can be or is performed from that location.

Thus, there is a need for improving measuring the amount of work and productivity in forest operations.

### SUMMARY

In this disclosure, a method is presented to measure work performance and productivity. It combines the use of Remote Sensing, Tracking trail during Performance Movement and the Reach to a work performance measurement that can be used for example for work production measurements. The Method differs from the methods known to mankind before by using the Tracking information and the work quantification to measure and report work performed, not to predict work production. It improves the work performance measurements significantly in areas of work where the work quantification is unpractical or costly to acquire.

If information is available on actual work sites, presenting the tracking trail and the area where the work has been completed, the Reach of the said equipment or person or, furthermore, the equipment-person combination, can be analyzed and presented as an empirically defined parameter. Further on, the value of the reach at each case may be predicted using a model between the reach and the corresponding equipment, personnel and work condition factors.

Combining the reach and the tracking trail, a reasonable evaluation can be made of the locations where the work may be performed. The equipment or personnel may travel in the work region without performing any work. This travel does not contribute to the immediate results of the work, even though it may or may not be necessary for the work performance. Such moving is called “the slack movement” in this document, while the movement in the work area (“the work area”) when the work of interest for the measurements is performed is called “the performance movement” in this document. For identifying the areas where the work has been performed, it is important to separate these two movements from each other. The work area may be defined as a geometric area that can be represented for example by a geometric polygon, surface, selection of cells in a grid or selection of pixels from a rater or any other way to represent areas in geographic setting.

For the purpose of following work performance, it may be of interest to measure the work completion inside a given Work Area. A system presenting the proportion or percentage of total amount of work performed would provide value to the work production monitoring.

An optional representation of work production is presented in form of work completion. Work completion is tightly connected to the work production, essentially, comparing the production completed to the total amount of work in a given work area.

In an aspect a method of measuring work production in forest operations is disclosed. The method comprises receiving cells of work quantification information from remote sensing; receiving the tracking trail information of equipment or personnel; analyzing tracking trail to identify the cells of the work quantification information to identify the cells where the tracked equipment or personnel has conducted work; and summarizing work production from the cells identified.

The method according to the aspect provides an ability to quantify or measure work production in forest operations without manual measurements or other sensors on board the working individual or working machine than a positioning equipment. There are many cases where attaching such additional sensors may not be practical, desired or possible.

In an implementation the method further comprises receiving reach information. The reach information of the equipment used in the work is beneficial as it can be used in calculations. The reach information may be collected during the work so that it is known actually how far the equipment reached during the work, however, the information may represent the theoretical maximum or an estimate of the reach in the given conditions. This information improves the calculation.

In an implementation the method further comprises receiving reference measurement; performing model calibration between summarized work production and the reference measurement; and performing calibrated work production measurement calculation. This provides an ability to perform the process of aspect with higher accuracy when compared to the reference measurement.

In an implementation the method further comprises receiving work mode information; and said analyzing comprises analyzing tracking trail and work mode to identify the cells of the work quantification information to further identify the cells where the tracked equipment or personnel has conducted work while being in work mode. This provides an ability to perform a process described above in conditions where the equipment may be moving but not performing effective work all the time.

In an implementation the method further comprises receiving work area Information; and said analyzing comprises analyzing tracking trail to identify the cells of the work quantification information inside the work area to further identify the cells where the tracked equipment or personnel has conducted work. This provides an ability to perform a process described above but also limiting the work production measurements to the Work Area.

In an implementation the method further comprises receiving work area Information; and said analyzing comprises analyzing tracking trail and work mode to identify the cells of the work quantification information inside the work area to further identify the cells where the tracked equipment or personnel has conducted work. This provides an ability to perform to perform a process described above in conditions where the equipment may be moving but not performing effective work all the time, also limiting the work production measurements to the work area.

In an implementation the method further comprises receiving empirical data of the work reach used and the equipment or personnel or working conditions; building a model between the reach as dependent variable and at least one of the equipment or personnel or working conditions as independent variables; and using the said model to predict the reach parameter value in the production measurements. This provides an ability to perform a process described above but using the calibration to Reference Measurement for improved accuracy.

In an implementation the method further comprises presenting the work completion information as a ratio of the amount of work completed on a work area and the summarized total amount of work in the work area, wherein the presentation of completion may be made as a percentage or a visual presentation. This provides the ability to present the information of work completion or use it in planning or monitoring operations.

The aspects and implementations described above may be implemented, in addition to a method, as an apparatus and a computer program configured to perform the method described above.

### BRIEF DESCRIPTION OF THE DRAWINGS

The accompanying drawings, which are included to provide a further understanding of the method to measure work production in forest operations and constitute a part of this specification, illustrate embodiments and together with the description help to explain the principles of a system and method of measuring work production in forest operations. In the drawings:

FIG. 1 a flow diagram of an example of the process of measuring work production in forest operations,

FIG. 2 an example of a work area,

FIG. 3 an example of a work quantification information cells,

FIG. 4 an example of a tracking trail,

FIG. 5 an example of an area within reach of the equipment,

FIG. 6 an example of all cells with centroid inside the area within reach of the equipment is disclosed.

### DETAILED DESCRIPTION

Reference will now be made in detail to the embodiments, examples of which are illustrated in the accompanying drawings.

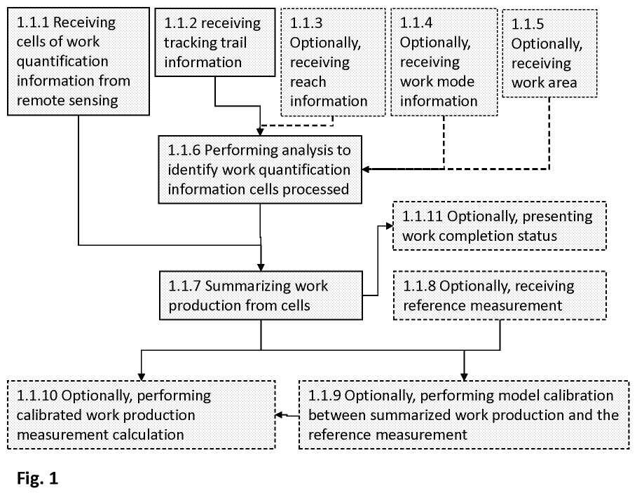

In the following description method to measure work production in forest operations is disclosed. An example of such method is shown in FIG. 1.

Receiving Cells of Work Quantification Information from Remote Sensing 1.1.1

Acquiring information on the work targets with remote sensing has been done in the industry. (Alam, M M, Strandgard, M, Brown, M W, Fox, J C. 2011 “Harvesting productivity analysis using LiDAR” 11th International Conference on LiDAR Applications for Assessing Forest Ecosystems Conference Handbook/pp. 1-10;) For example, in forest management processes, information about the forest stands have been collected. Similarly, in many countries, national forest inventory includes production of continuous information layers about forests. A person or team skilled in the art of natural resource inventory is capable of producing such information. In one embodiment, a raster image may be used to store the information, each pixel presenting the values of attributes of interest. In another embodiment, a grid data may be used, where geometries are presenting the extent of each information unit and attributes are indicating the values of interest.

One practical approach of acquiring information on natural resources with remote sensing is to cover the area of interest with remote sensing data, connect it to some measurements of the work quantity, making a model to predict the quantity over the entire area of interest.

There are other approaches to acquire information on work targets with remote sensing, but the method mentioned here disclose the idea of this phase. In this disclosure, the work target information is received from some remote sensing process.

The format of the cells of work quantification Information may be for example, but is not limited to the following formats:
Raster image, containing the information as image cells.
Polygons in a systematic grid of squares or hexagons or triangles, connected with attributes.
Polygons of any free form, connected with attributes.
Point location records, connected with attributes

All above formats may be practically stored in a database or an information file.

Receiving the Tracking Trail Information 1.1.2

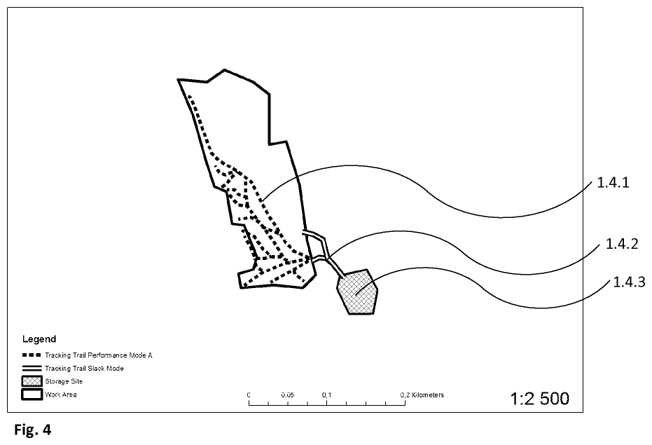

Modern positioning technologies include global satellite navigation systems (GNSS), but can also use other kinds of means to measure positions of the equipment and the personnel. Tracking trail information is a time series log of location measurements, indicating the location of the equipment or personnel at given points of time. An example of a tracking trail 1.4.1 information is shown in FIG. 4. In FIG. 4 examples of tracking trail slack mode 1.4.2 and storage site 1.4.3 are shown. This information is received to the system for example by means of telecommunication, by wire from the positioning systems or by a removable media. Equipment and persons have been tracked frequently (Oliveira, A. Wisser, R, Acuna, M & Morgenroth, J.: 2015. “Automatic GNSS-enabled harvester data collection as a tool to evaluate factors affecting harvester productivity in a Eucalyptus spp. harvesting operation in Uruguay”. International Journal of Forest Engineering. Volume 27, 2016—Issue 1)

Optionally, Receiving the Reach Information 1.1.3

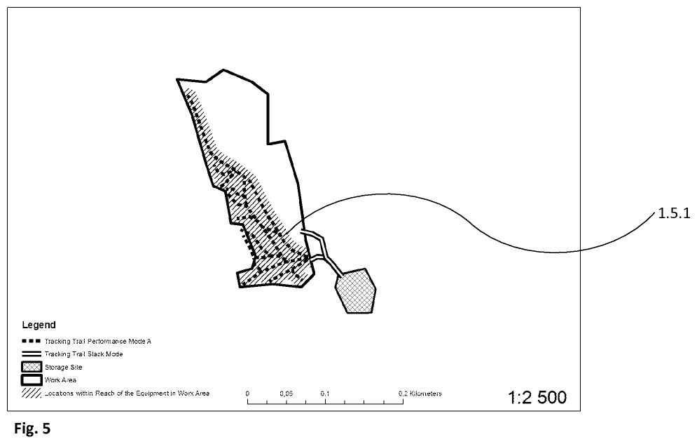

Equipment and personnel tend to be able to perform work at their area of reach. Thus, it may be beneficial to receive this information in the process. Sometimes, the maximum reach may be non-practical to work on, so smaller than maximum reach is used to perform the work tasks. This disclosure does not take position to the type of reach used, but as one example, the practical reach of a feller-buncher logging equipment may be the distance from the machine positioning equipment location to the point where it is efficient to operate the boom and the tools to cut trees. The reach may be different in slope, flat area, soft or hard soils, correspondingly. To know where the work is performed from a given tracking trail, it is important to understand the Reach. Area within the reach of equipment 1.5.1 is shown in FIG. 5.

Optionally, receiving the work area 1.1.5

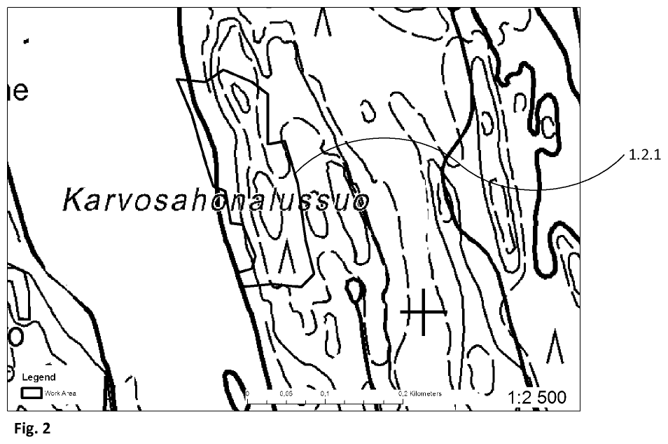

Sometimes, when operating equipment, it may be practical to position the equipment outside the actual target of work and reach to the work area. An example of a work area 1.2.1 is shown in FIG. 2. FIG. 2 For example, some terrain conditions or an attractive access from outside the work target may encourage reaching the target from outside. In this kind of case, it may be important to understand that the work target was reached from such a location where the full reach of the equipment or personnel was not processed. By presenting the work area, the quantification of work production may be limited to actions that happen inside the work area.

Optionally, Receiving the Work Mode Information 1.1.4

The equipment or personnel may travel in the work region without performing any work. This travel does not contribute to the immediate results of the work, even though it may or may not be necessary for the work performance. Such moving is called “the slack movement” in this document, while the movement in the work area (“the work area”) when the work of interest for the measurements is performed is called “The Performance Movement” in this document. For identifying the areas where the work has been performed, it is important to separate these two movements from each other.

Performance/slack movement is mode information that may be received from the equipment system, sensors, by manual input, or deducted from the tracking trail properties (for example, speed of the equipment). Whatever is the source, the work mode Information identifies the time in the tracking trail when the equipment or personnel is conducting work.

Performing Analysis to Identify Work Quantification Information Cells Processed 1.1.6

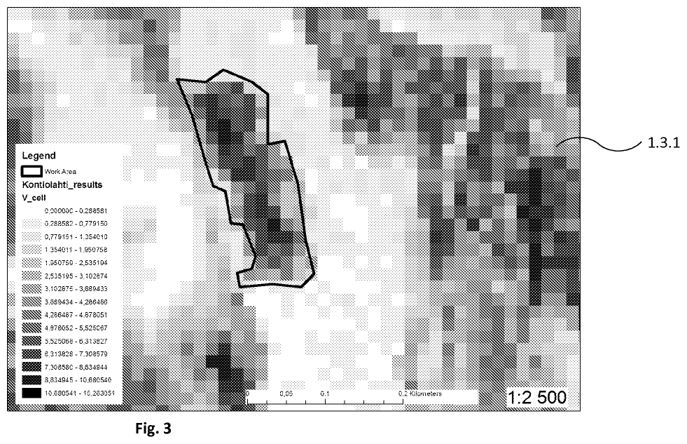

To measure the amount of work processed, it is necessary to identify the work quantification information cells that are processed. An example of work quantification information cells 1.3.1 is shown in FIG. 3. This is done by using the tracking trail, reach and the optional information of work mode and work area, to analyze the area within reach of the equipment. One practical embodiment of this information is the following process:

1. Organize the time—location records in the order of the time

2. Select from the tracking trail, the records taken during the time period. Optionally, identify all records where the mode is “performance”. Further on, optionally, form groups of records, where the work mode is continuously “performance”. Whether you used the options or no, the resulting output is a time-ordered list of location records.

3. Connect the time—location—records to form a polyline geometry.

4. Use a geographic proximity analysis operation “buffer” (known to anyone specialized in the industry of geographic information) to identify all locations that can be reached from the tracking Trail. To achieve this, use the Reach as the buffer distance. The areas within the buffer distance from the tracking trail are called “the buffer”. The buffer is not the only way to analyze proximity. There may be other approaches, for example using a geographic operation “spatial join” or other analysis indicating proximity of analysis cells to the tracking trail. In the purpose of this disclosure, it is not significant what method is used to identify the locations that can be reached from the tracking trail. For simplicity, later in this document the identification of locations within the reach of the equipment from tracking trail are called “The Buffer” even if other type of proximity analysis was used.

5. Use geographic “cut” operation to identify all locations inside the work area that are within the buffer. The output is called “the area within reach of the equipment”. It is good to note that the tracking trail does not need to be inside the work area; it is enough to be able to reach to the work area to perform work.

6. Use geographic “select by location” operation to select all cells of work quantification Information that are within the area within reach of the Equipment. Depending on the size and shape of the cells of work quantification information, it may be practical to use operation of selecting all cells whose centroid is within the area within reach of the equipment. Alternatively, it is possible to select all cells of work quantification information that intersect the area within reach of the equipment or some other practical form of coincidence. In another alternative embodiment, a “spatial join” or other geographic proximity operation is performed to identify the cells of work quantification information that are within the Reach of the equipment.

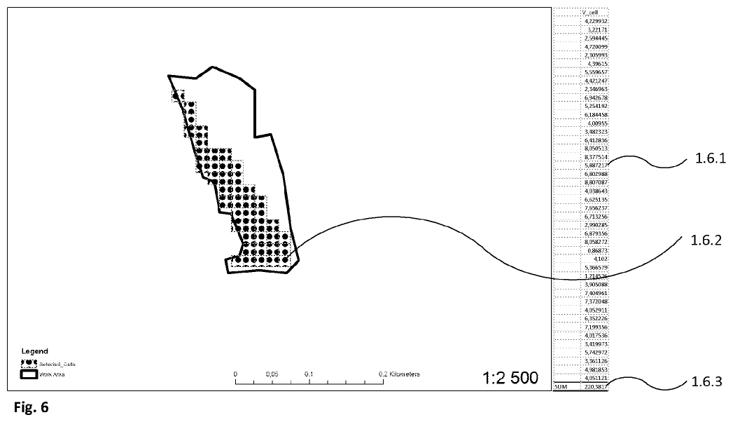

7. Optionally, cut the parts of the cells of work quantification information that are within the area within reach of the equipment. Calculate the proportion of each cell that is inside the area within reach of the equipment. Use the proportion of the area inside/outside to multiply the work quantification information to attribute the work quantification information to each part of the cell that is inside. If the cell size is small relative to the area operated, it may be practical to just select entire cells whose centroid is inside the area within reach of the equipment and use the work quantification information of the entire cells. The output of each of these options is a set of cells or proportions of cells that are identified to contain the Work Quantification Information processed. An example of all cells with centroid inside the reach of equipment 1.6.2 is shown in FIG. 6. In FIG. 6 also examples of a summary 1.6.3 of the work quantification in cells 1.6.1 is shown.

8. Record the time each cell or proportion of a cell in the work quantification information was contained by some area within reach of the equipment for the first time. It is practical to assume the cell was processed the first time it was contained by some area within reach of the equipment. Optionally, the cells may be attributed with the work mode information during the time of access to the given cell. Optionally, the time stamp may be only marked to the cell if it was within reach of the tracking trail and the work mode was indicating that the performance movement is on.

Summarizing Work Production from Cells 1.1.7

A practical process to summarize work production from Cells 1.1.7 may be the following:

1. Identify the time period you want to summarize

2. Identify the cells of work quantification that have been processed the first time within your desired time period.

3. Make a summary of the cells or proportions of cells of work quantification identified. A simple sum of the work quantifications is a practical way to summarize, but other statistics may be used.

Optionally, Presenting Work Completion Status 1.1.11

Work completion status may be of interest in work production measurements. For example, owner or manager of logging business may have an interest to know the percentage of completion on a given work site. If the work area is presented and the work quantification information is available, the total amount of work at the work area can be calculated by summarizing the work quantification information inside the work area. Using the summarized work production from cells (1.1.7) the summarized work Production may be compared to the total amount of work on the work area, presenting the work completion. Work completion may be presented as a proportion, percentage, a visual gauge, bar or by any other means that may be illustrative or descriptive to the user.

Optionally, Receiving Reference Measurement 1.1.8

In real life situations, the work may not be performed 100% in all cells of work quantification. For example, if the work performed is timber or wood logging, some trees may be left non-processed to the Work Area for whatever reason. In case like this, the Work Quantification Information summarized may not totally coincide with the actual work done. Additionally, the work quantification Information may originate from information that is produced for another kind of usage in mind. For example, timber volume measurements may be done using different definition of minimum top diameter of the usable stem. If such information is used for work quantification, which may be a common case in practical life, there may be a deviation between the work quantification information and the actual work performance experienced.

This deviation may be corrected, assuming the amount of work left non-finished or performed in excess when compared to the work quantification Information is somewhat systematic proportion of the total work quantified, by optionally, performing model calibration for Improved Precision 1.1.9. Reference measurement of the actual work performed (for example, the amount of timber and wood processed; measured from the wood and timber products that are finished), when linked to the time period when the said work was done, can be used to calibrate a correction model. The summarization result of the work production from cells 1.1.7 of the said time is processed, and the result is recorded. This record is connected to the reference measurement received, linked to the same time period. Several of these connected work Production—reference measurement pairs are produced.

Optionally, Performing Model Calibration Between Summarized Work Production and the Reference Measurement 1.1.9

A model is calibrated to predict the reference measurement values with the work production values. The resulting output is a calibration model for work production results.

In practical embodiment, the model is a parametric linear or non-linear model.

In other practical embodiment, the model may be a non-parametric model.

Optionally, Performing Calibrated Work Production Measurement Calculation 1.1.10

Optionally, the summarized work production from Cells 1.1.7 may be corrected to calibrated work production from cells by optionally, performing calibrated work production measurement calculation 1.1.10. The output of this calculation is the calibrated work production measurement.

The above described method may be implemented as computer software which is executed in a computing device. When the software is executed in a computing device it is configured to perform the above described inventive method. The software is embodied on a computer readable medium so that it can be provided to the computing device.

The computing device mentioned above may be a general purpose or special purpose computer comprising at least one processor for executing computer programs and at least one memory for storing computer programs and related data. The computing device is configured to cause the method described above when a computer program is executed in the computing device.

As stated above, the components of the exemplary embodiments can include a computer readable medium or memories for holding instructions programmed according to the teachings of the present embodiments and for holding data structures, tables, records, and/or other data described herein. A computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the method to measure work production in forest operations may be implemented in various ways. The method to measure work production in forest operations and its embodiments are thus not limited to the examples described above; instead they may vary within the scope of the claims.

1. A method of measuring work production in forest operations which method comprising:
receiving cells of work quantification information from remote sensing;
receiving the tracking trail information of equipment or personnel;
analyzing tracking trail to identify the cells of the work quantification information to identify the cells where the tracked equipment or personnel has conducted work; and
summarizing work production from the cells identified.

2. The method according to claim 1, wherein the method further comprising:
receiving reach information.

3. The method according to claim 1, wherein the method further comprising:
receiving reference measurement;
performing model calibration between summarized work production and the reference measurement; and
performing calibrated work production measurement calculation.

4. The method according to claim 1, 2 or 3, claim 1, wherein the method further comprising:
receiving work mode information; and
said analyzing comprises analyzing tracking trail and work mode to identify the cells of the work quantification information to further identify the cells where the tracked equipment or personnel has conducted work while being in work mode.

5. The method according to claim 1, which method comprising:
receiving work area information;
said analyzing comprises analyzing tracking trail to identify the cells of the work quantification information inside the work area to further identify the cells where the tracked equipment or personnel has conducted work.

6. The method according to claim 1, which method comprising:
receiving work area information; and
said analyzing comprises analyzing tracking trail and work mode to identify the cells of the work quantification information inside the work area to further identify the cells where the tracked equipment or personnel has conducted work.

7. A method according to claim 1, which method further comprising:
receiving empirical data of the work reach used and the equipment or personnel or working conditions;
building a model between the reach as dependent variable and at least one of the equipment or personnel or working conditions as independent variables;
using the said model to predict the reach parameter value in the production measurements.

8. The method according to claim 1, wherein the method further comprises:
presenting the work completion information as a ratio of the amount of work completed on a work area and the summarized total amount of work in the work area, wherein the presentation of completion may be made as a percentage or a visual presentation.

9. A computer program configured to cause the method according to claim 1, when said computer program is executed in a computing device.

10. An apparatus for measuring work production in forest operations, the apparatus comprising at least one processor and at least one memory, wherein the apparatus is configured to perform a method according to claim 1.
